(19) United States
(12) Patent Application Publication
(10) Pub. No.: US 2013/0100441 A1
(43) Pub. Date: Apr. 25, 2013

(54) OPTICAL INSPECTION APPARATUS AND EDGE INSPECTION DEVICE

(71) Applicant: Hitachi High-Technologies Corporation, Tokyo (JP)

(72) Inventors: Yuta TAGAWA, Hitachinaka (JP); Takuaki SEKIGUCHI, Honjo (JP); Yoshiyuki MOMIYAMA, Yokohama (JP)

(73) Assignee: HITACHI HIGH-TECHNOLOGIES CORPORATION, Tokyo (JP)

(21) Appl. No.: 13/659,440

(22) Filed: Oct. 24, 2012

(30) Foreign Application Priority Data
Oct. 24, 2011 (JP) 2011-233438

(51) Int. Cl. G01N 21/00

(52) U.S. Cl. 356/237.5

(57) ABSTRACT

The invention provides an optical inspection apparatus having an edge inspection device capable of accommodating wide positional changes in the edges of wafers.

The optical inspection apparatus comprises the following components: a surface inspection device 300 for inspecting the surfaces of a wafer 100 for defects; a wafer stage 210 located on the wafer transfer path along which the wafer 100 is transferred to the surface inspection device 300; an edge inspection module 530 for inspecting the edge of the wafer 100 when the wafer 100 is on the wafer stage 210; and a module mover 650 for moving the edge inspection module 530 along the optical axis of the edge inspection module 530.

### BACKGROUND OF THE INVENTION

1. Field of the Invention

The present invention relates to optical inspection apparatuses and edge inspection devices for inspecting semiconductor wafers for defects.

2. Description of the Related Art

A semiconductor chip is fabricated by forming an integrated circuit on a semiconductor wafer through the steps of resist application, photolithography, etching, resist removal, and so on. Typically the wafer is inspected for defects between these steps. Among such wafer inspections is an edge inspection in which the edge of the wafer is inspected for defects.

In a typical wafer inspection, the top and bottom surfaces of a wafer are examined for any signs of foreign substances, cracks, film thickness unevenness, film peeling, and so forth, and less emphasis is placed on the inspection of the wafer edge. However, increases in wafer diameter and smaller process nodes have led to some problems. For instance, defects on the edge of a wafer are now more likely to cause foreign substances, resulting in a decrease in yield. Similarly, cracks on the wafer edge are more likely to cause breakage of the wafer, necessitating the halt of the inspection device.

When 300-mm wafers were first introduced, wafer breakage was not an unusual phenomenon during the heating process, which places a higher thermal load on wafers. At first, it was suspected that such wafer breakage was due to the trouble of the wafer fabrication devices, but eventually it was found out that scars or foreign substances on the wafers' edges were responsible. Today, defects on the edge of a wafer have a great influence even on immersion lithography, a semiconductor fabrication process. In immersion lithography, purified water is fed to the gap between a wafer and the lens of a lithographic system, thereby increasing lithographic resolution. The water, however, is often contaminated by defects on the wafer edge, resulting in wafer pattern defects. Defects on the wafer edge not only affect the quality of the wafer itself, but adversely affect other wafer treatment devices as well. Thus, to reduce the influence of that defective wafer on other wafers, a considerable amount of time has to be spent on cleaning the treatment devices.

Therefore, greater importance is now being attached to wafer edge defect management. Thus far, various techniques have been proposed for wafer edge inspection (see JP-2003-139523-A, JP-2007-256272-A, WO/2006/112466, JP-2006-308360-A, JP-2006-64975-A, and JP-2006-128440-A).

### SUMMARY OF THE INVENTION

In wafer edge defect management, a wafer is placed on a rotatable table, and the entire outer-circumferential edge of the wafer is examined while the wafer is being rotated relative to an inspection mechanism. However, when the center of the wafer is not in perfect agreement with the rotational center of the table, the distance between the wafer edge and the inspection mechanism fluctuates periodically during the wafer's rotation. As a result, the position of the wafer edge may fall out of the focal depth of the inspection mechanism, and the inspection may not be conducted properly.

However, it is not necessarily an easy task to ensure the accurate positioning of the wafer relative to the table. Difficulties are involved also in preventing fluctuations in the distance between the inspection mechanism and the wafer edge during the wafer's rotation because wafer roundness differs slightly from wafer to wafer. In this case, it is conceivable that the focal point of the optical system of the inspection mechanism could be made adjustable according to changes in the distance between the inspection mechanism and the wafer edge. However, large-sized wafers (e.g., 300-mm wafers) have a wide range of fluctuation in their edge positions, and the diameters of wafers may further be increased in the near future. Thus, such focal adjustment alone is not enough for accommodating positional changes in the edges of wafers.

The present invention has been contrived to solve the above problems, and one of the objects of the invention is to provide an optical inspection apparatus having an edge inspection device capable of accommodating wide positional changes in the edges of wafers.

To achieve the above object, the present invention provides an optical inspection apparatus comprising: a surface inspection device for inspecting the surfaces of a wafer for defects; a wafer stage located on a wafer transfer path leading to the surface inspection device; an edge inspection module for inspecting the edge of the wafer when the wafer is on the wafer stage; and a module mover for moving the edge inspection module along the optical axis of the edge inspection module.

In accordance with the invention, wide positional changes in the edges of wafers can be accommodated.

### BRIEF DESCRIPTION OF THE DRAWINGS

FIG. 1 is a schematic illustrating the overall structure of an optical inspection apparatus according to an embodiment of the invention;

FIG. 2 is a cross section of a wafer to be inspected;

FIG. 3 is a top view illustrating the basic structure of an edge inspection device incorporated in the optical inspection apparatus;

FIG. 4 is a side view illustrating the structure of the edge inspection device;

FIG. 5 is a functional block diagram of the controller of the optical inspection apparatus;

FIG. 6 is a timing chart of the operations performed by the optical inspection apparatus;

FIG. 7 is a flowchart of the edge inspection and surface inspection controlled by the controller; and

FIG. 8 is a table of a judgment pattern used by the wafer-quality evaluating unit of the optical inspection apparatus.

### DESCRIPTION OF THE PREFERRED EMBODIMENTS

An embodiment of the present invention will now be described with reference to the accompanying drawings.

### (1) Overall Structure of Optical Inspection Apparatus

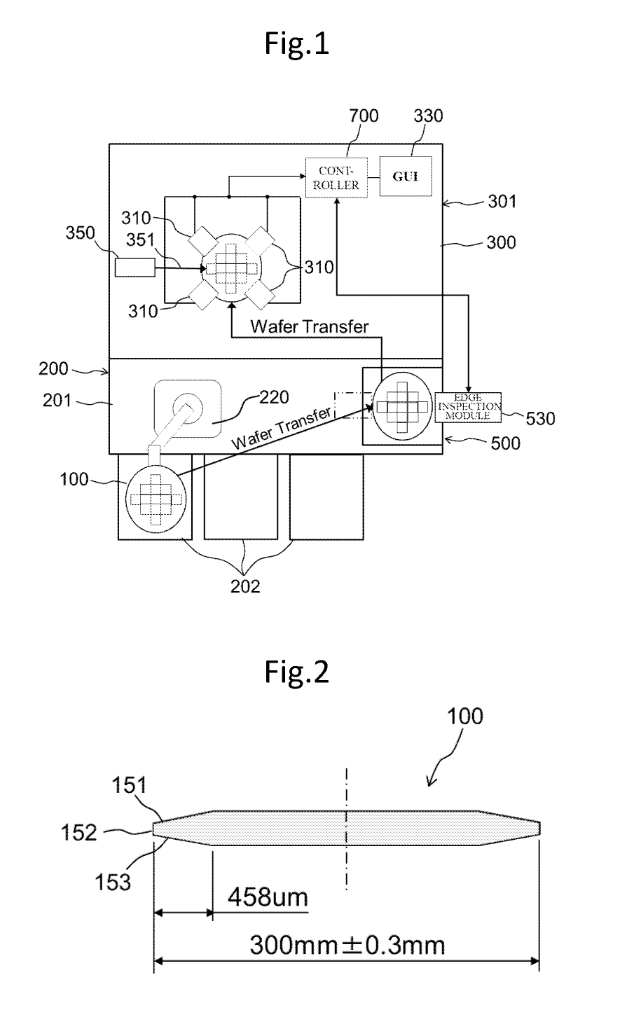

FIG. 1 is a schematic illustrating the overall structure of an optical inspection apparatus according to an embodiment of the invention.

The optical inspection apparatus includes the following components: a surface inspection device 300 for examining the top and bottom surfaces of a wafer 100 for defects; an edge inspection device 500 installed on the transfer path along which the wafer 100 is transferred to the surface inspection device 300; and at least one load port 202 (the present embodiment assumes the use of three load ports 202) for loading/unloading the wafer 100 into/from the optical inspection apparatus. The optical inspection apparatus further includes the following components: a wafer transfer device 200 for transferring the wafer 100 among the load ports 202, the edge inspection device 500, and the surface inspection device 300; a controller 700 for controlling the operation of the surface inspection device 300, the edge inspection device 500, and the wafer transfer device 200; and a GUI display 330 for displaying an operation interface and inspection results.

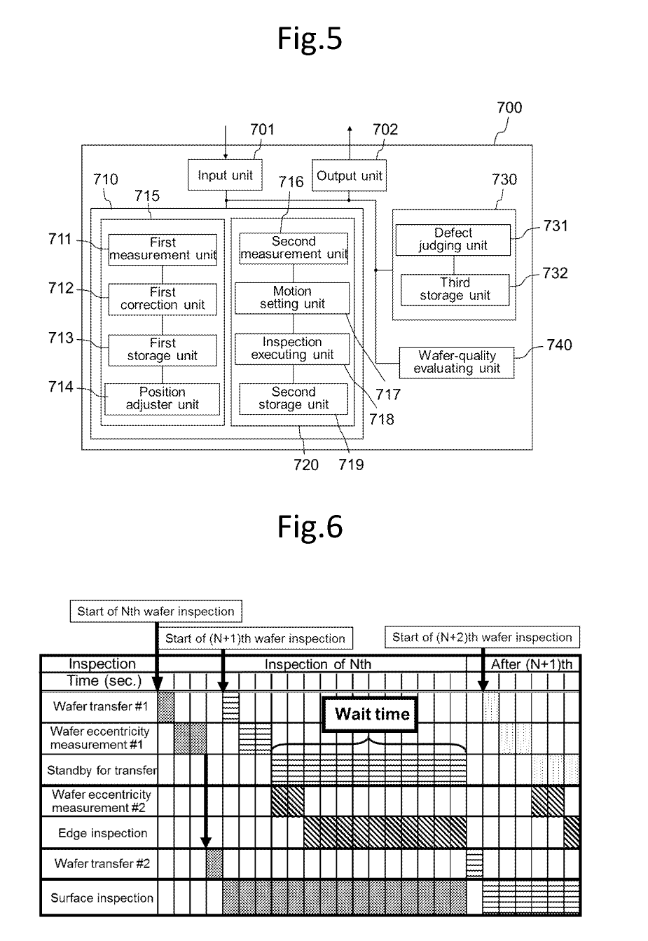

The surface inspection device 300 includes the following components: a wafer stage (not illustrated) on which to place the wafer 100; an optical illuminator 350 for radiating inspection light 351 onto the wafer 100 placed on the stage; light receivers 310 for receiving the light scattered from the wafer 100; a surface inspection executing unit 730 (see FIG. 5) for examining the positions and sizes of defects on the wafer 100 based on signals received from the light receivers 310; and a main frame 301 for housing these components.

The wafer transfer device 200 is located between the surface inspection device 300 and the load ports 202. The main frame 201 of the wafer transfer device 200 houses a transfer arm 220 and the edge inspection device 500.

The edge inspection device 500 is located within the main frame 201 of the wafer transfer device 200. The edge inspection device 500 includes the following components: a wafer stage 210 (see FIG. 4) for holding the wafer 100 in position; an edge inspection module 530 for examining the edge of the wafer 100 placed on the stage 210; and a module mover 650 for moving the edge inspection module 530. It should be noted that the edge inspection module 530 is located away from the wafer transfer path that extends within the wafer transfer device 200. If the edge inspection module 530 of the edge inspection device 500 is installed on the wafer transfer path as depicted by the two-dot chain line of FIG. 1, the edge inspection module 530 needs to have an anti-collision mechanism to avoid contact with the wafer 100 being transferred. However, this may result in generation of dust particles and reduced inspection accuracy. To avoid such unwanted consequences, the edge inspection module 530 is installed across from the transfer arm 220 with the wafer stage 210 located between. In other words, the edge inspection module 530 is located at a side section of the edge inspection device 500 as illustrated in FIG. 1.

### (2) Wafer 100

FIG. 2 is a cross section of a wafer 100 to be inspected.

The wafer 100 is circular when viewed from above or below (i.e., from the top side or the bottom side of FIG. 2). On the other hand, the outermost edge of the wafer 100 in cross section is tapered (i.e., without top and bottom square corners). In the explanation that follows, the vertically extending edge surface (outermost edge) is referred to as the apex 152, the top slanted portion that extends downwardly toward the apex 152 as the top bevel 151, and the bottom slanted portion that extends upwardly toward the apex 152 as the bottom bevel 153. Thus, when we are referring to the word “the edge” of the wafer 100, it is meant to include those three surfaces: the top bevel 151, the apex 152, and the bottom bevel 153. Note also that the edge inspection device 500 is designed to examine the three surfaces with a single optical illuminator/detector mechanism. In accordance with the SEMI standard of a 300-mm wafer, the diameter of the wafer 100 is 300±0.3 mm, and the horizontal distance from the inner edge of the top bevel 151 or of the bottom bevel 153 to the apex 152 is 458 μm or thereabout. While the optical inspection apparatus of the present embodiment is intended to inspect wafers 100 each with such top and bottom bevels, it is also capable of inspecting those without bevels.

### (3) Structure of Edge Inspection Device 500

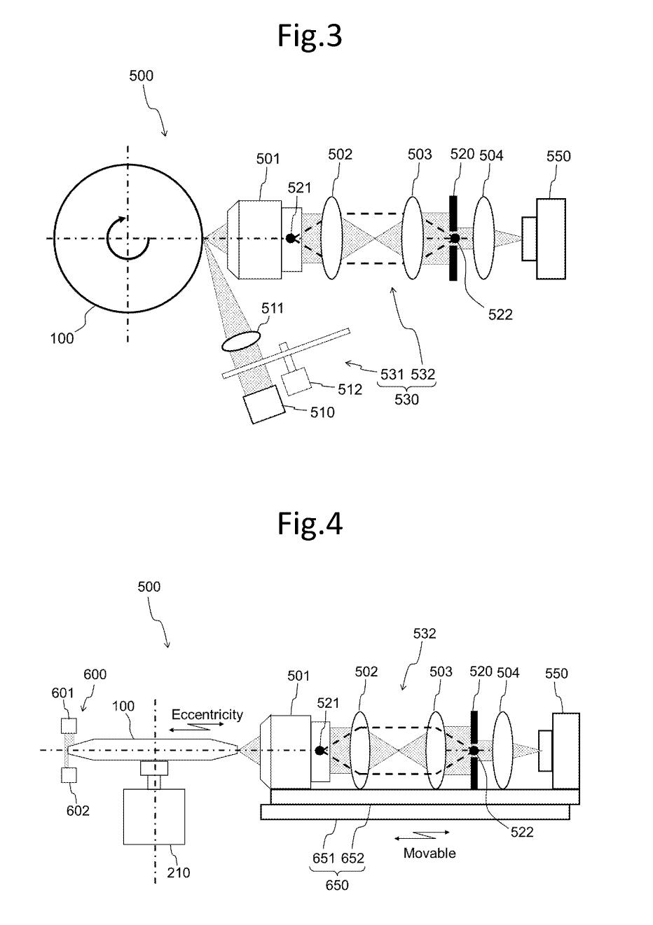

FIG. 3 is a top view illustrating the basic structure of the edge inspection device 500.

As illustrated in the figure, the edge inspection module 530 of the edge inspection device 500 includes an optical illuminator 531 for radiating inspection light onto the edge of a wafer 100 and an optical detector 532 for detecting the light scattered from the wafer edge.

The optical illuminator 531 includes the following components: a light source 510, such as a semiconductor laser (laser diode) or the like, for radiating inspection light; a condenser 511 for focusing the inspection light onto the edge of the wafer 100; and a diffuser plate 512 for shifting the phase of the inspection light to reduce speckle noise.

The optical detector 532 includes the following components: an objective lens 501, a lens 502, and a lens 503 through which the light scattered from the wafer edge passes; a condenser 504 for focusing the light passing through the lenses 502 and 503; a line sensor 550 for receiving the light focused by the condenser 504; and an aperture 520 (i.e., a stop) located between the lens 503 and the condenser 504. This optical detector 532 works in the following manner. After the scattered light from the wafer edge is turned into parallel light by the objective lens 501, the lens 502 focuses the parallel light. The lens 503 then turns the focused light into parallel light again. Thereafter, the condenser 504 focuses the light that has passed through the aperture 520, thereby focusing an image of the wafer edge onto the light receiving surface of the line sensor 550.

The aperture 520 is located at the exit pupil 522 that has a conjugate relation with the entrance pupil 521 of the objective lens 501. The reason is to ensure an adequate focal depth and prevent a decrease in dark-field image contrast. The size of the aperture 520 is made small enough for all of the top bevel 151, apex 152, and bottom bevel 153 to lie within the focal depth. In the present embodiment, the focal depth of the optical detector 532 is 458 μm or greater. In order to position the aperture 520 at the location of the exit pupil 522, the aperture 520 is created such that the aperture 520 lies outside of the lenses 502 and 503 (see FIG. 3). The reason for placing the aperture 520 at the exit pupil 522 is that, in the present embodiment, the entrance pupil 521 of the optical detector 532 lies within the objective lens 501, meaning that the aperture 520 cannot be placed at the entrance pupil 521. However, if the entrance pupil 521 lies outside of the objective lens 501, the aperture 520 can instead be placed at the entrance pupil 521.

FIG. 4 is a side view illustrating the structure of the edge inspection device 500.

As can be seen, the edge inspection device 500 includes the above-mentioned wafer stage 210 and module mover 650. The wafer stage 210 can be a typical one used for an optical inspection apparatus. For example, it is possible to use the wafer holder of a wafer pre-aligner, which is used for wafer notch detection and wafer positioning. The wafer stage 210 is located on the transfer path along which a wafer 100 is transferred to the surface inspection device 300. The wafer 100 is placed on the wafer stage 210 by the transfer arm 220 of the wafer transfer device 200 and then transferred to the surface inspection device 300 by the transfer arm 220. The wafer stage 210 can hold the wafer 100 by vacuum suction, for example. The wafer holding section of the wafer stage 210 is rotated with the use of a motor, whereby the wafer 100 on the stage 210 can be rotated as well (see FIG. 3).

The module mover 650 is used to move the edge inspection module 530 (i.e., the optical illuminator/detector mechanism) along the optical axis of the optical detector 532. The module mover 650 comprises a base 651 and a movable stage 652 that slides on the base 651. The edge inspection module 530 is mounted on this movable stage 652, which slides along the optical axis of the optical detector 532.

The edge inspection device 500 further includes an eccentricity measuring instrument 600 for measuring the eccentricity of the wafer 100 placed on the wafer stage 210. As the eccentricity measuring instrument 600, it is possible to use a typical one used for the wafer pre-aligner of an optical inspection apparatus. Using a light receiver 602, the eccentricity measuring instrument 600 detects the position where the wafer 100 blocks the inspection light radiated by a light emitter 601 via a projection lens. More specifically, the eccentricity measurement is performed in the following manner. After the inspection light (parallel light) radiated from the light emitter 601 passes through a band-pass filter within the light receiver 602, the one-dimensional CCD image sensor of the light receiver 602 captures the light. The eccentricity measuring instrument 600 then detects the edge position of the wafer 100 by examining the shadow resulting from the wafer's interference in the parallel light (the size of the shadow changes according to the size of the wafer 100). The eccentricity measuring instrument 600 performs the above operations while rotating the wafer 100 with the wafer stage 210 and transmits the results to the controller 700.

### (4) Controller 700

FIG. 5 is a functional block diagram of the controller 700.

The controller 700 includes the following components: an input 701 and an output 702 for signals; an edge inspection executing unit 710 for performing edge inspection of a wafer 100; the above-mentioned surface inspection executing unit 730 for performing surface inspection of the wafer 100; and a wafer-quality evaluating unit 740 for judging whether post-surface-inspection steps can be performed for the wafer 100. The edge inspection executing unit 710 comprises a first processing unit 715 and a second processing unit 720. The first processing unit 715 includes the following components: a first measuring unit 711 for measuring the eccentricity of the wafer 100 relative to the rotational center of the wafer stage 210; a first correction unit 712 for calculating a correction value for the wafer 100 based on the measured eccentricity; a first storage unit 713 for storing the measurement results obtained by the first measuring unit 711 and the calculation results obtained by the first correction unit 712; and a position adjuster unit 714 for instructing the transfer arm 220 to perform repositioning of the wafer 100. The second processing unit 720 includes the following components: a second measuring unit 716 for re-measuring the eccentricity of the repositioned wafer 100; a motion setting unit 717 for creating a control sequence for the module mover 650 based on the measurement results obtained by the second measuring unit 716; an inspection executing unit 718 for executing edge inspection; and a second storage unit 719 for storing the measurement results obtained by the second measuring unit 716, the control sequences created by the motion setting unit 717, and the inspection results obtained by the inspection executing unit 718. Finally, the surface inspection executing unit 730 includes a defect judging unit 731 for examining defects on the wafer 100 and a third storage unit 732 for storing the examination results.

### (5) Operation

FIG. 6 is a timing chart of the operations performed by the optical inspection apparatus.

As illustrated in FIG. 6, the controller 700 first transfers an Nth wafer 100 stored in a load port 202 to the wafer stage 210 with the use of the transfer arm 220 (“wafer transfer #1” in FIG. 6). The eccentricity measuring instrument 600 then measures the eccentricity of the Nth wafer 100 while the wafer is being rotated (“wafer eccentricity measurement #1 in FIG. 6). After the eccentricity measurement, the transfer arm 220 transfers the Nth wafer 100 to the surface inspection device 300 (“wafer transfer #2” in FIG. 6). Receiving an instruction from the surface inspection executing unit 730, the surface inspection device 300 starts to inspect the top and bottom surfaces of the Nth wafer 100 for defects (“surface inspection” in FIG. 6). In this surface inspection, the inspection light 351 radiated from the optical illuminator 350 is scanned across the Nth wafer 100 while the wafer is being rotated. The defect judging unit 731 then acquires information on defect positions and sizes from the scattered light information obtained by the light receivers 310 and stores the defect data on the third storage unit 732. This defect data can be output to and displayed on the display device 330.

For the (N+1)th wafer and subsequent wafers, the controller 700 also performs edge inspection in addition to the surface inspection.

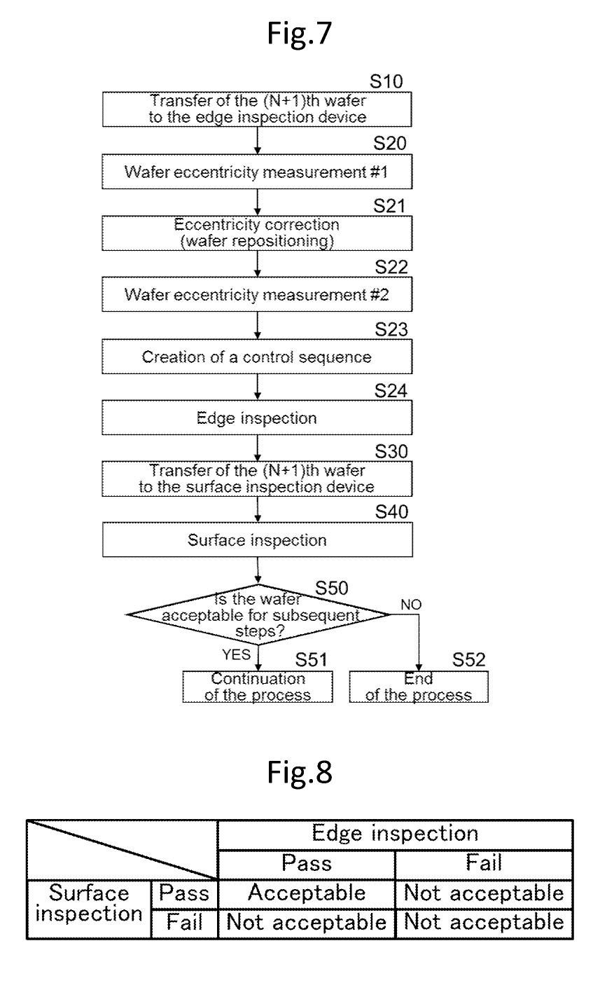

FIG. 7 is a flowchart of the edge inspection and surface inspection controlled by the controller 700.

The following describes the operations to be performed for the (N+1)th wafer and subsequent wafers.

After the Nth wafer is transferred to the surface inspection device 300 (“wafer transfer #2” in FIG. 6), inspection of the (N+1)th wafer is started at the same time as the start of the Nth-wafer surface inspection. Specifically, the controller 700 first instructs the transfer arm 220 to move the (N+1)th wafer stored in a load port 202 to the wafer stage 210 (“wafer transfer #1” in FIG. 6; Step S10 in FIG. 7). Thereafter, the first measuring unit 711 of the first processing unit 715 starts eccentricity measurement of the (N+1)th wafer (“wafer eccentricity measurement #1” in FIG. 6; Step S20 in FIG. 7). Right after the eccentricity measurement of the (N+1)th wafer, the surface inspection of the Nth wafer is still in progress. Thus, the (N+1)th wafer cannot be transferred from the wafer stage 210 until the surface inspection of the Nth wafer is completed (i.e., until the Nth wafer is transferred out of the surface inspection device 300). Accordingly, the (N+1)th wafer is put on standby for transfer for a given amount of time (see “wait time” in FIG. 6).

The present embodiment thus exploits this waiting period, allowing edge inspection of the (N+1)th wafer to be performed during the waiting period. Specifically, the result of the (N+1)th wafer eccentricity measurement is first retrieved from the first storage unit 713. The first correction unit 712 then uses this result to calculate a correction value for reducing the eccentricity of the (N+1)th wafer on the wafer stage 210. Based on the correction value, the position adjuster unit 714 instructs the transfer arm 220 to perform repositioning of the (N+1)th wafer on the wafer stage 210 (Step S21 in FIG. 7). After the repositioning of the (N+1)th wafer, the second measuring unit 716 of the second processing unit 720 re-performs eccentricity measurement of the (N+1)th wafer and stores the result on the second storage unit 719 (“wafer eccentricity measurement #2” in FIG. 6; Step S22 in FIG. 7).

After the second eccentricity measurement of the (N+1)th wafer, the motion setting unit 717 creates a motion sequence for the module mover 650 and the wafer stage 210 based on the eccentricity information of the (N+1)th wafer, so that the edge of the (N+1)th wafer will not fall out of the focal depth of the edge inspection device 500 while the wafer is being rotated (Step S23 in FIG. 7). Based on the created motion sequence, the inspection executing unit 718 controls the motions of the module mover 650 and the wafer stage 210. More specifically, the inspection executing unit 718 maintains a fixed distance between the edge of the (N+1)th wafer and the edge inspection module 530 by allowing the module mover 650 to move the edge inspection module 530 back and forth relative to the (N+1)th wafer being rotated. While performing the above operation, the inspection executing unit 718 acquires information on the positions and sizes of defects on the edge of the (N+1)th wafer by examining the light scattered from the wafer edge (“edge inspection” in FIG. 6; Steps S24 in FIG. 7). The obtained defect data is stored on the second storage unit 719 and can be output to and displayed on the display device 330.

The edge inspection of the (N+1)th wafer ends almost at the same time as the surface inspection of the Nth wafer (see FIG. 6). After these two inspections are completed, the controller 700 instructs the transfer arm 220 to move the Nth wafer out of the surface inspection device 300 and to move the (N+1)th wafer from the wafer stage 210 to the surface inspection device 300 (“wafer transfer #2” in FIG. 6; Step S30 in FIG. 7). The surface inspection device 300 then performs surface inspection of the (N+1)th wafer based on an instruction from the surface inspection executing unit 730 (“surface inspection” in FIG. 6; Step S40 in FIG. 7). Specifically, while the (N+1)th wafer is being rotated, the inspection light 351 from the optical illuminator 350 is scanned across the (N+1)th wafer. The defect judging unit 731 then acquires information on defect positions and sizes from the scattered light information obtained by the light receivers 310 and stores the acquired defect data on the third storage unit 732. The defect data can be output to and displayed on the display device 330.

Thereafter the controller 700 instructs the wafer-quality evaluating unit 740 to judge whether or not the (N+1)th wafer is acceptable enough to undergo subsequent steps (Step S50 in FIG. 7), based on the edge inspection results stored on the second storage unit 719 and the surface inspection results stored on the third storage unit 720. In this judgment, a maximum acceptable defect size or number is set in advance as a threshold. When the actual number of defects on the (N+1)th wafer or the size of the largest defect on the (N+1)th wafer exceeds the threshold, the wafer is judged to be unacceptable. If not, the wafer is judged to be acceptable. As illustrated in FIG. 8, when the (N+1)th wafer passes both of the edge inspection and the surface inspection, the wafer is judged acceptable enough to undergo subsequent steps (Step S51 of FIG. 7). When, on the other hand, the (N+1)th wafer fails to pass either of the two inspections, the wafer is judged unacceptable and thus incapable of undergoing subsequent steps (Step S52 of FIG. 7).

The above operations are performed in the same manner for subsequent wafers (i.e., the (N+2)th wafer, the (N+3)th wafer, and so forth). That is, while an edge inspection and a surface inspection are performed simultaneously, each wafer is subjected to the judgment of the wafer-quality evaluating unit 740.

It should be noted that while FIG. 6 illustrates an example in which edge inspection of the Nth wafer is skipped, it is also possible to perform an edge inspection on the Nth wafer before executing a surface inspection.

### (6) Advantages

In the above-described embodiment, the module mover 650 moves the edge inspection module 530 of the edge inspection device 500 back and forth relative to a wafer 100 when the center of the wafer 100 is displaced from the rotational center of the wafer stage 210 or when the width of the wafer's sway resulting from the rotation of the wafer 100 exceeds the focal depth of the edge inspection module 530. Accordingly, the position of the wafer's edge is prevented from falling out of the focal depth of the edge inspection module 530. This in turn ensures proper edge inspection and reliable edge inspection results. Moreover, because of the movable edge inspection module 530, flexible focal-point adjustment is possible even for large-sized wafers whose edges tend to sway widely or for those wafers expected to become larger in size in the near future. Therefore, the edge inspection device 500 can accommodate wide positional changes in the edges of wafers.

Further, the motion setting unit 717 of the controller 700 is designed to produce the profile of the entire outer-circumferential edge of a wafer 100 while associating the eccentricity measurement results obtained by the eccentricity measuring instrument 600 with command values specifying the rotational motion of the wafer stage 210. Using this profile data, the motion setting unit 717 creates a motion sequence, which is used to control the module mover 650 and the wafer stage 210. Thus, the focal point of the edge inspection module 530 can be directed easily to the edge of the wafer 100.

As stated above, the optical inspection apparatus of the present embodiment is intended to inspect wafers 100 each with top and bottom bevels 151 and 153. For that purpose, the aperture 520 is provided at the optical detector 532 of the edge inspection module 530, and the numerical aperture (NA) of the aperture 520 is reduced properly to ensure an adequate focal depth. Accordingly, the three edge surfaces of a wafer 100 (i.e., the apex 152, the top bevel 151, and the bottom bevel 153) can be vividly captured in a dark-field image with the use of a single optical illuminator/detector mechanism (i.e., the edge inspection module 530). This is more advantageous in terms of installation space than when multiple optical detectors are provided to examine the apex 152, the top bevel 151, and the bottom bevel 153 of a wafer 100. This is also advantageous in that the edge inspection module 530 can be installed in a narrow space within the wafer transfer device 200 and in that less equipment cost is required. Furthermore, placing the aperture 520 at a conjugate pupil of the objective lens 501 can offset decreases in image contrast which result from reducing the NA of the aperture 520 for the purpose of ensuring an adequate focal depth. Decreases in the amount of light receivable due to the reduced NA can be offset by using a semiconductor laser or the like for the light source 510. Speckle noise resulting from the use of a semiconductor laser can be prevented by the diffuser plate 512. In addition, because the edge inspection module 530 of the present embodiment is a dark-field optical unit, increasing the sensitivity of the edge inspection module 530 can compensate for the resolution decrease due to the reduced NA.

Typically, wafer edge inspection is done with a dedicated edge inspection device. A dedicated edge inspection device, however, is low in inspection throughput, reducing the production rate of semiconductor chips. Further, when a dedicated edge inspection device is used, a surface inspection device is also required as a discrete device, resulting in a drastic increase in equipment cost.

In contrast, the present embodiment is designed such that edge inspection of a wafer 100 is performed during surface inspection of another wafer 100 (i.e., during the time period that is typically used a waiting period). Thus, the throughput of the surface inspection can be prevented from decreasing. In addition, since the edge inspection device 500 is installed at the wafer transfer device 200 attached to the surface inspection device 300, a dedicated discrete edge inspection device is not necessary, whereby equipment cost increases can be avoided.

1. An optical inspection apparatus comprising:
a surface inspection device for inspecting the surfaces of a wafer for defects;
a wafer stage located on a wafer transfer path leading to the surface inspection device;
an edge inspection module for inspecting the edge of the wafer when the wafer is on the wafer stage; and
a module mover for moving the edge inspection module along the optical axis of the edge inspection module.

2. The apparatus of claim 1 further comprising:
an eccentricity measuring instrument for measuring the eccentricity of the wafer when the wafer is on the wafer stage;
a motion setting unit for creating a motion sequence for the module mover and the wafer stage based on the result of the eccentricity measurement, so that the edge of the wafer will not fall out of the focal depth of the edge inspection module while the wafer is being rotated; and
an inspection executing unit for instructing the edge inspection module to inspect the edge of the wafer for defects while at the same time controlling the module mover and the wafer stage based on the created motion sequence to maintain a fixed distance between the edge of the wafer and the edge inspection module.

3. The apparatus of claim 1 or 2,
wherein the edge of the wafer includes an outer-circumferential surface and top and bottom bevels that extends in a slanted manner toward the outer-circumferential surface,
wherein the edge inspection module includes an optical detector and an aperture stop that is located at the entrance pupil or the exit pupil of the optical detector, and
wherein the diameter of the aperture stop is set such that the entire wafer edge including the outer-circumferential surface and the top and bottom bevels lies within the focal depth of the edge inspection module.

4. The apparatus of claim 1, further comprising:
a wafer transfer device, attached to the surface inspection device, for transferring the wafer to the surface inspection device,
wherein the edge inspection module is installed at the wafer transfer device.

5. The apparatus of claim 1, further comprising:
a controller for exercising control such that during surface inspection of the wafer by the surface inspection device, the edge inspection module performs an edge inspection on another wafer.

6. The apparatus of claim 1, wherein the edge inspection module is a dark-filed inspection module.

7. The apparatus of claim 1, wherein the edge inspection module includes a light source for radiating laser light as inspection light and a diffuser plate for reducing the speckle noise of the inspection light,

8. An edge inspection device comprising:
a wafer stage;
an edge inspection module for inspecting the edge of a wafer placed on the wafer stage; and
a module mover for moving the edge inspection module along the optical axis of the edge inspection module.

9. The device of claim 8 further comprising:
an eccentricity measuring instrument for measuring the eccentricity of the wafer placed on the wafer stage;
a motion setting unit for creating a motion sequence for the module mover and the wafer stage based on the result of the eccentricity measurement, so that the edge of the wafer will not fall out of the focal depth of the edge inspection module while the wafer is being rotated; and
an inspection executing unit for instructing the edge inspection module to inspect the edge of the wafer for defects while at the same time controlling the module mover and the wafer stage based on the created motion sequence to maintain a fixed distance between the edge of the wafer and the edge inspection module.

10. The device of claim 8 or 9,
wherein the edge of the wafer includes an outer-circumferential surface and top and bottom bevels that extends in a slanted manner toward the outer-circumferential surface,
wherein the edge inspection module includes an optical detector and an aperture stop that is located at the entrance pupil or the exit pupil of the optical detector, and
wherein the diameter of the aperture stop is set such that the entire wafer edge including the outer-circumferential surface and the top and bottom bevels lies within the focal depth of the edge inspection module.
